(19) United States
(12) Patent Application Publication
(10) Pub. No.: US 2015/0334345 A1
(43) Pub. Date: Nov. 19, 2015

(54) VEHICLE COMMUNICATION SYSTEM

(71) Applicant: Russell Fichera, Methuen, MA (US)

(72) Inventor: Russell Fichera, Methuen, MA (US)

(21) Appl. No.: 14/710,728

(22) Filed: May 13, 2015

Related U.S. Application Data
(60) Provisional application No. 61/992,297, filed on May 13, 2014.

(51) Int. Cl. H04N 7/14; B60R 11/02

(52) U.S. Cl. CPC H04N 7/142; B60R 11/02; B60R 2011/0294; B60R 2011/004

(57) ABSTRACT

A communication system coupled between a law enforcement vehicle and a stopped vehicle that includes an extendable and retractable boom coupling from a control means on the law enforcement vehicle. The boom includes an end sensor positionable relative to a driver side view mirror of the stopped vehicle. The control means being responsive to a sensed signal from the end sensor for controlling the extended and retracted position of the boom.

### RELATED CASES

Priority for this application is hereby claimed under 35 U.S.C. §119(e) to commonly owned and co-pending U.S. Provisional Patent Application No. 61/992,297 which was filed on May 13, 2014 which is incorporated by reference herein in its entirety.

### FIELD OF THE INVENTION

The present invention relates in general to a vehicle communication system and pertains more particularly to a system that can communicate effectively between a law enforcement vehicle and a vehicle being stopped.

### BACKGROUND OF THE INVENTION

One system that describes a vehicle observation apparatus is found in U.S. Pat. No. 7,642,899 to Alvarado et al. This patent describes an observation apparatus for reducing the risk of injury to law enforcement persons particularly during a vehicle stop. As such, the apparatus is provided with a telescopic boom that interconnects from the roof of the law enforcement vehicle outwardly to the side of the vehicle being stopped. Means are provided for two-way communication and observation so that the law enforcement officer can effectively communicate with the person in the stopped vehicle without the law enforcement officer leaving his vehicle. U.S. Pat. No. 7,642,899 to Alvarado et al is hereby incorporated by reference herein in its entirety.

It is an object of the present invention to provide an improved vehicle communication system that also employs an extendable and retractable boom but which is preferably mounted from a front fender of the law enforcement vehicle and that has improved control means particularly for accurately positioning the communication link at the side window of the driver that is being stopped.

### SUMMARY OF THE INVENTION

To accomplish the foregoing and other objects, features and advantages of the present invention, there is provided an improved vehicle communication system which is characterized by at least two improvements over the prior art. First, the system on the law enforcement vehicle is preferably fender mounted. Secondly, the positioning of the boom and a portion of the two-way communication system is accurately controlled in accordance with the present invention by sensing the boom position relative to a driver side view mirror of the stopped vehicle.

In accordance with the present invention there is provided a communication system coupled between a law enforcement vehicle and a stopped vehicle that includes an extendable and retractable boom coupling from a control means on the law enforcement vehicle. The boom includes an end sensor positionable relative to a driver side view mirror of the stopped vehicle. The control means is responsive to a sense signal from the end sensor for controlling the extended and retracted position of the boom.

In accordance with other aspects of the present invention the control means is preferably mounted on the law enforcement vehicle fender; the end sensor is either a proximity sensor or a touch sensor; the end sensor detects the position of the end sensor relative to the driver side view mirror; including a communication apparatus including a first communication part in the law enforcement vehicle and a second communication part mounted at a distal end of the boom; wherein the communication apparatus includes both audio and video communication pieces; the second communication part is mounted so that when the boom is located distally the second communication part is disposed adjacent to the vehicle side window; the boom is controlled by the control means between a withdrawn position that is nested at the law enforcement vehicle, and an extended position where the second communication part is arranged adjacent to the vehicle side window in a position for observation inside the stopped vehicle; and the boom is operated to move from the extended position to the nested position in 5 seconds or less.

In accordance with another version of the present invention there is provided a vehicle communication system used by a law enforcement vehicle for communicating with a vehicle that has been stopped by the law enforcement vehicle, said stopped vehicle having a driver side view mirror. The system comprises: an elongated boom that has a withdrawn position in which the boom is nested and an extended position in which the boom is extended so that a free end of the boom is placed adjacent to a driver side window of the stopped vehicle; the elongated boom being mounted at the law enforcement vehicle in a position to be extended forward of the law enforcement vehicle toward the stopped vehicle; a control member mounted at the law enforcement vehicle for the law enforcement officer to control the movement of the boom between the nested and extended position of the boom; a two-way communication apparatus for communication between an occupant of the stopped vehicle and the law enforcement officer and including a first communication part at the law enforcement vehicle and a second communication part mounted at a distal end of the boom arranged adjacent to a stopped vehicle side window in a position for communication between the occupant of the stopped vehicle and the law enforcement officer; and a sensor arrangement also mounted at the distal end of the boom for detecting the position of the boom relative to the driver side view mirror in order to control the extended position of the boom.

In accordance with still other aspects of the present invention the two-way communication apparatus is comprised of a first communication portion adjacent to the stopped vehicle driver side window when the boom is extended and a second communication portion at the law enforcement vehicle; the communication apparatus includes both audio and video communication pieces; the control member comprises a first control part at a proximal end of the boom for controlling at least a longitudinal direction movement of the boom between the nested and extended position of the boom, a second control part at the law enforcement vehicle, and a control line coupled between the first and second control parts to enable the officer in the law enforcement vehicle to control the position of the boom via the second control part; the two-way communication apparatus also includes a communication link coupled between the respective first and second communication portions in order to enable both visual observation of the stopped vehicle and audio communication between the stopped vehicle and the law enforcement vehicle

In accordance with another embodiment of the present invention there is provided a method of audio and visual communication between a law enforcement vehicle and a stopped vehicle comprising providing an extendable and retractable boom, controlling the length of extension of the boom from the law enforcement vehicle by providing an end sensor at a distal end of the boom so as to control the position of the boom relative to a driver side view mirror of the stopped vehicle. The end sensor determines a distance between the end of the boom and the driver side view mirror in order to control the extended position of the boom. The communication includes providing two-way communication by having a first communication portion adjacent to the stopped vehicle driver side window when the boom is extended and a second communication portion at the law enforcement vehicle. The sensing is by means of either a proximity sensing or a touch sensing.

### BRIEF DESCRIPTION OF THE DRAWINGS

It should be understood that the drawings are provided for the purpose of illustration only and are not intended to define the limits of the disclosure. The foregoing and other objects and advantages of the embodiments described herein will become apparent with reference to the following detailed description when taken in conjunction with the accompanying drawings in which:

FIG. 1 is a schematic perspective illustration showing the law enforcement vehicle, the stopped vehicle and the communication system of the present invention;

FIG. 2 is a partial plan view illustrating the end of the boom and the positioning relative to the stopped vehicle;

FIG. 3 is a further schematic illustration showing in somewhat more detail the side-view mirror and the terminal free end of the boom; and

FIG. 4 is a block diagram illustrating the components and operation of the communication system of the present invention.

### DETAILED DESCRIPTION

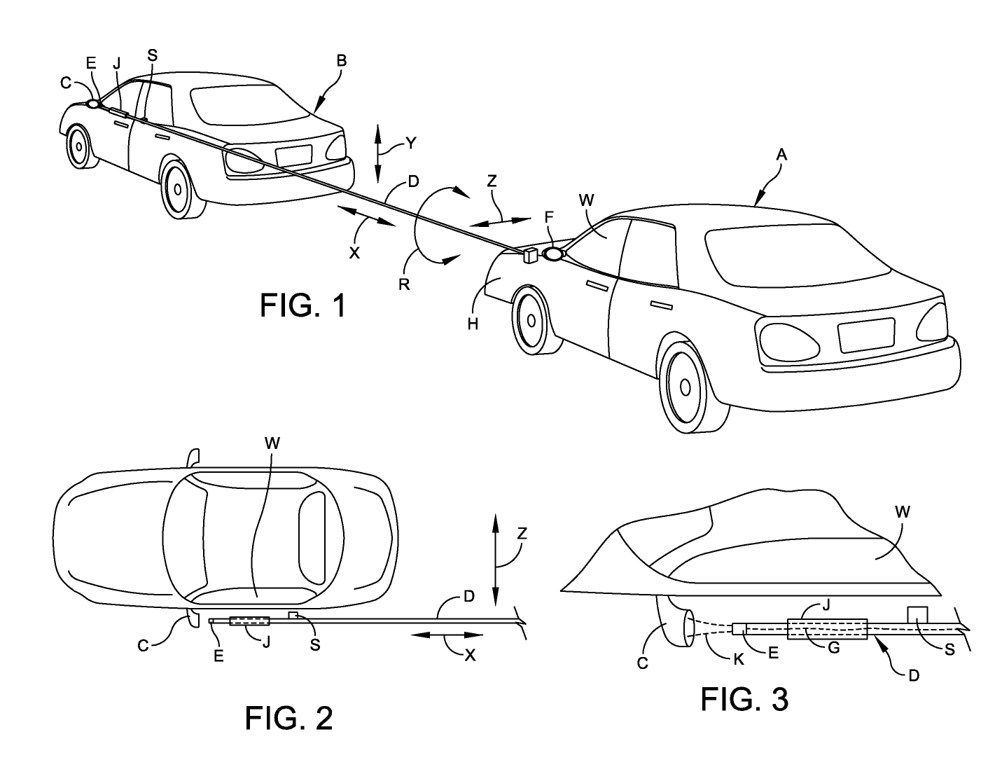

Reference is now made to FIG. 1 and a schematic illustration of the law enforcement vehicle at A and the stopped vehicle at B. It is noted that the stopped vehicle is provided with a side-view mirror C. Virtually any vehicle is equipped with a side view mirror, and it is one objective of the present invention to use the side view mirror as a means by which the length of extension of the boom can be controlled. The boom is preferably a telescopic boom or mast that can be constructed in multiple inter-engaging segments. By sensing the location of the terminal free end of the boom relative to the side view mirror, there is then provided an effective way to properly position the terminal free end of the boom and thus also properly position the communication apparatus that is partially contained adjacent to the terminal free end of the boom. In this way the communication apparatus can be positioned adjacent to the side window at the driver side of the stopped vehicle. This communication apparatus may comprise known audio and visual communication equipment that enables the officer to both talk with the stopped driver as well as to visually observe the stopped driver through the side window of the vehicle.

The system of the present invention is preferably mounted at the law enforcement vehicle fender H. The boom D itself may be of a type as described in U.S. Pat. No. 7,642,899 to Alvarado et al. There is also schematically illustrated a control box or control means F that is adapted to support the extendable and retractable boom D. At least part of the control of the boom is preferably by means of a switch arrangement (not shown) that may be mounted inside the vehicle A at a convenient location and operated by the officer to control the forward and backward movement of the boom D.

FIGS. 1-3 also illustrate by the axes X, Y and Z the different directions that the boom can be controlled. The “X” direction is indicated as the direction of extension and retraction of the boom D. Moreover, the control means F can also control a rotation of the boom D about its longitudinal axis as indicated by the arrow R in FIG. 1. This control may be in alternate rotational directions as indicated by the two-headed arrow R. Also controlled by means F is the Y direction which controls vertical movement of the boom D indicated by arrow Y in FIG. 1; and the Z direction which controls lateral movement of the boom D as indicated by arrow Z in FIG. 1.

As indicated previously, there is a two-way communication apparatus or system. One of the ends of this communication system may be provided at the control means F and the other end of the communication system is illustrated in the schematic diagram of FIG. 2 by the box J. The box J may include both audio and visual communication equipment so that the law enforcement officer can talk to the occupants of the stopped vehicle and receive oral communications from the individual, as well as providing a display wherein the law enforcement officer can readily observe the area of the stopped individual inside the vehicle at least in the area near the side window of the stopped vehicle.

In accordance with the present invention, it is important that the communication apparatus at box J be positioned effectively relative to the side window W illustrated in FIG. 2. For this purpose, the end of the boom D is provided with a sensor that is illustrated at E in FIG. 3. In accordance with the present invention the sensor may be either a proximity sensor or a touch sensor. FIG. 3 also illustrates wiring at G coupling to the sensor E and communicating back to the control means F. In actuality, the wiring G may be representative of both control wiring for the boom, as well as communication wiring to enable audio and visual communication between the officer and stopped vehicle occupant via the control box J and communication means at the law enforcement vehicle.

The sensor E may be a proximity sensor preferably directed at the rearview mirror C as illustrated by the dotted outline in FIG. 3 at K. Because every vehicle has to be provided with a side view mirror, this provides an effective means by which the system can assist in the positioning of the boom and the proper positioning of the communication box J relative to the stopped vehicle window W. By knowing the relative positioning of the sensor E and the communication box J, one can effectively control the “X” positioning of the boom D. FIG. 2, in particular, shows the distal end of the boom positioned relative to the side view mirror C so that the communication box at the stopped vehicle window is in a proper position for communication with the occupant of the stopped vehicle.

The proximity sensor E may be of conventional design and can intercept reflections from the mirror C so as to determine the distance of the end sensor to the mirror and thus also closely control the position of the communication box J relative to the occupant's window W. Alternatively, a detection system may be employed that has a touch sensor as the sensing element E. Any known touch sensor may be employed. This operates so that once the sensor senses a touching at the mirror, then the boom stops extending via a sensing at the control means F. In that case the operation may be such that the boom is extended and when the free end where the sensor is located touches the mirror surface that “touch” is sensed in order to stop the extended position of the boom D. The communication box J, in that case, would then be positioned so that, once the boom is stopped, via the touch sensing, the box J is positioned at the proper position relative to the side window W, for ready observation of the occupant in the stopped vehicle. The proper position is considered to be at about midway of the side window W in the X direction. In an still alternate arrangement, after the touch sensor touches at the mirror, the control may be such that the boom is withdrawn a predetermined distance in order to properly position the communication box J at the desired location relative to the vehicle side window W, such as midway of the side window W.

One of the features of the present invention is the ability for two-way communication between vehicles A and B. Included in the system is a monitor in the law enforcement vehicle A. Actually, multiple monitors may be provided. One preferred location for a monitor is on the back of the sun visor. This position of the monitor allows for a quick reaction time for the officer. There can also be provided a side camera that is comparable to the typically-used dash camera presently available on cruisers. The camera system of the present invention is primarily used to view inside the stopped vehicle. In this way, the law enforcement officer can readily gauge as to whether there is any existing threat by approaching the vehicle. This enables the law enforcement officer to make a quick assessment of the occupant or occupants of the stopped vehicle even before the law enforcement officer leaves his vehicle.

Another feature of the present invention relates to the speed with which the boom D can be extended and retracted; particularly the retraction speed. It is preferred that there is an ability to retract the boom within 5 seconds or less. This could be important should the stopped vehicle decide to flee the scene. It is necessary then to be able to retract the boom quickly in order to pursue the vehicle. Another feature of the present invention relates to having the operation of the boom be activated automatically. This is possible by sensing when the siren or blue lights are turned on the law enforcement vehicle. Once this occurs, when the law enforcement vehicle is stationary, the boom then automatically extends. This control may remain on until it is manually turned off by the officer. This is important in that the cameras begin recording images and sound upon activation. This shut off of the system occurs concurrent with the officer turning off the blue lights and siren.

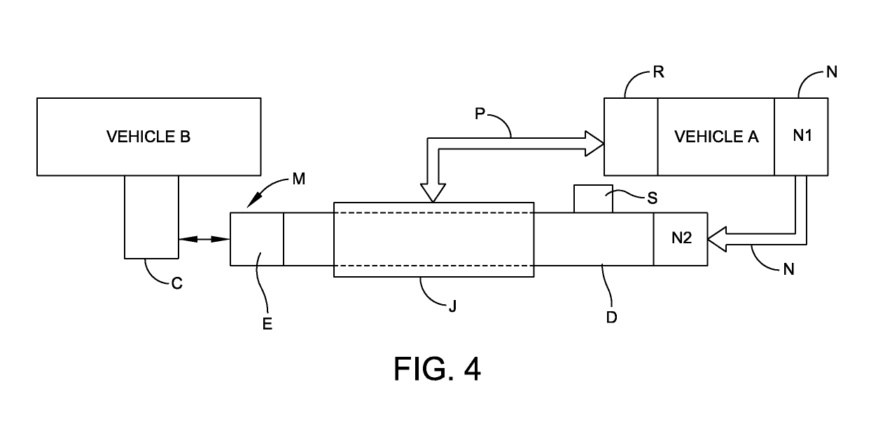

Thus, in accordance with the present invention there is provided a vehicle communication system used by a law enforcement vehicle A for communicating with a vehicle B that has been stopped by the law enforcement vehicle. The stopped vehicle B has a driver side view mirror C. The system of the present invention includes an elongated boom D that has a withdrawn position in which the boom is nested and an extended position in which the boom is extended so that a free distal end M of the boom D is placed adjacent to a driver side window W of the stopped vehicle B. Refer to FIGS. 1-3 showing the boom in the fully extended position so that the communication member J is properly positioned relative to the stopped driver side window W. The boom control is also illustrated in the block diagram of FIG. 4 by means of a first control part N2 at a proximal end of the boom for controlling at least a longitudinal directional movement of the boom between the nested and extended position of the boom, a second control part N1 at the law enforcement vehicle A, and a control line N coupled between the first and second control parts (N1, N2) to enable the officer in the law enforcement vehicle A to control the position of the boom D via the second control part N1. The system further provides that the elongated boom is mounted at the law enforcement vehicle A in a position to be extended forward of the law enforcement vehicle toward the stopped vehicle B.

The system further includes a two-way communication apparatus (J, R, P) for communication between an occupant of the stopped vehicle B and the law enforcement officer and including a first communication part R at the law enforcement vehicle and a second communication part J mounted at a distal end of the boom arranged adjacent to a stopped vehicle side window W in a position for communication between the occupant of the stopped vehicle B and the law enforcement officer vehicle A. A sensor arrangement E is also mounted at the distal M of the boom D for detecting the position of the boom relative to the driver side view mirror C in order to control the extended position of the boom D. The communication apparatus may be conventional relying on an audio interface so that the officer can talk with the stopped vehicle occupant and so that the occupant can, in turn, talk with the officer. This means that some type of audio communication arrangement is coupled between the pieces J and R in FIG. 4. Also, observation can occur using a camera at the member J so that a visual picture is observable by the officer in vehicle A. This camera may also be controlled for at least slight motion so as to be able to scan inside the vehicle throughout the entire internal driving area.

The controls N1 and N2 (FIG. 4) may include controls as described in U.S. Pat. No. 7,642,899 to Alvarado et al. As mentioned before the forward control may be activated based on the vehicle A being stopped and the flashing lights of the vehicle A being illuminated. Alternatively, the control of the boom position may be only by a control mechanism at N1 in the vehicle A to extend and retract the boom. The mechanism N1 may include switches, a joystick, or other manually operable mechanism to impart movement to the boom. The mechanism N2 may be any one of a number of different types including gear mechanisms or motor drive mechanisms. However, this control is essentially overridden by means of the sensor arrangement at E in FIG. 4 wherein the sensor determines the proper desired forward position of the boom, and thus also the proper forward position of the communication mechanism (J), so that the occupant of the stopped vehicle can be observed and effectively communicated with. This observation and communication it is noted can also be accomplished without the officer leaving the vehicle A; thus making for a safer observation location for the officer.

As mentioned previously the sensor E may be either a proximity sensor or touch sensor. Sensors of this type are well-known and function on the basis of determining a location of a component relative to another component; in this case the position of the distal end M of the boom D relative to the driver side view mirror C, and thus accordingly relative to the side window W of the stopped vehicle B. As also mentioned before the boom D can be controlled in multiple ways including those identified in FIG. 1 by the directions X, Y, Z and R. FIG. 3 shows another sensor at S which can control the direction Z to some extent. It is noted that the sensor S is positioned mounted on the boom near its distal end but proximal of the sensor E. The sensor S faces the side of the vehicle B or the side window W. The sensor S may also be either a proximity or touch sensor but is preferably a proximity sensor that can determine how close the boom is to the side of the vehicle B. Feedback wiring can be used from the sensor S to the boom control N2 (FIG. 4) in order to control the Z (side-to-side) direction of the boom D so that the boom is properly position next to the vehicle B without making contact with the vehicle B.

In accordance with another aspect of the present invention there is provided a method of audio and visual communication between a law enforcement vehicle and a stopped vehicle comprising providing an extendable and retractable boom and controlling the length of extension of the boom from the law enforcement vehicle by providing an end sensor at a distal end of the boom so as to control the position of the boom relative to a driver side view mirror of the stopped vehicle. The end sensor determines a distance between the end of the boom and the driver side view mirror in order to control the extended position of the boom. By doing that the communication apparatus is then properly positioned fro communication between the officer in the law enforcement vehicle and the occupant of the stopped vehicle. The communication preferably includes providing two-way communication by having a first communication portion adjacent to the stopped vehicle driver side window when the boom is extended and a second communication portion at the law enforcement vehicle. The sensing of the boom position may be by means of either a proximity sensing or a touch sensing. FIGS. 1-3 show this final positioning. After the communication is completed then the boom can be manually controlled to retract back toward the law enforcement vehicle A.

Having now described a limited number of embodiments of the present invention, it should now be apparent to those skilled in the art that numerous other embodiments and modifications thereof are contemplated as falling within the scope of the present invention, as defined by the appended claims.

What is claimed is:

1. A communication system coupled between a law enforcement vehicle and a stopped vehicle that includes an extendable and retractable boom coupling from a control means on the law enforcement vehicle, said boom including an end sensor positionable relative to a side view mirror of the stopped vehicle, said control means responsive to a sense signal from the end sensor for controlling the extended and retracted position of the boom.

2. The communication system of claim 1 wherein said control means is mounted on the law enforcement vehicle fender.

3. The communication system of claim 1 wherein the end sensor is a proximity sensor.

4. The communication system of claim 1 wherein the end sensor is a touch sensor.

5. The communication system of claim 1 wherein the end sensor detects the position of the end sensor relative to the side view mirror.

6. The communication system of claim 5 including a communication apparatus including a first communication part in the law enforcement vehicle and a second communication part mounted at a distal end of the boom.

7. The communication system of claim 6 wherein the communication apparatus includes both audio and video communication pieces.

8. The communication system of claim 7 wherein the second communication part is mounted so that when the boom is located distally the second communication part is disposed adjacent to the vehicle side window.

9. The communication system of claim 6 wherein the boom is controlled by the control means between a withdrawn position that is nested at the law enforcement vehicle, and an extended position where the second communication part is arranged adjacent to the vehicle side window in a position for observation inside the stopped vehicle.

10. The communication system of claim 9 wherein the boom is operated to move from the extended position to the nested position in 5 seconds or less.

11. A vehicle communication system used by a law enforcement vehicle for communicating with a vehicle that has been stopped by the law enforcement vehicle, said stopped vehicle having a driver side view mirror, said system comprising:
an elongated boom that has a withdrawn position in which the boom is nested and an extended position in which the boom is extended so that a free end of the boom is placed adjacent to a driver side window of the stopped vehicle;
the elongated boom being mounted at the law enforcement vehicle in a position to be extended forward of the law enforcement vehicle toward the stopped vehicle;
a control member mounted at the law enforcement vehicle for the law enforcement officer to control the movement of the boom between the nested and extended position of the boom;
a two-way communication apparatus for communication between an occupant of the stopped vehicle and the law enforcement officer and including a first communication part at the law enforcement vehicle and a second communication part mounted at a distal end of the boom arranged adjacent to a stopped vehicle side window in a position for communication between the occupant of the stopped vehicle and the law enforcement officer;
and a sensor arrangement also mounted at the distal end of the boom for detecting the position of the boom relative to the driver side view mirror in order to control the extended position of the boom.

12. The communication system of claim 11 wherein the two-way communication apparatus is comprised of a first communication portion adjacent to the stopped vehicle driver side window when the boom is extended and a second communication portion at the law enforcement vehicle.

13. The communication system of claim 12 wherein the communication apparatus includes both audio and video communication pieces.

14. The communication system of claim 13 wherein the control member comprises a first control part at a proximal end of the boom for controlling at least a longitudinal direction movement of the boom between the nested and extended position of the boom, a second control part at the law enforcement vehicle, and a control line coupled between the first and second control parts to enable the officer in the law enforcement vehicle to control the position of the boom via the second control part.

15. The communication system of claim 14 wherein the two-way communication apparatus also includes a communication link coupled between the respective first and second communication portions in order to enable both visual observation of the stopped vehicle and audio communication between the stopped vehicle and the law enforcement vehicle.

16. The communication system of claim 11 wherein the control member comprises a first control part at a proximal end of the boom for controlling at least a longitudinal direction movement of the boom between the nested and extended position of the boom, a second control part at the law enforcement vehicle, and a control line coupled between the first and second control parts to enable the officer in the law enforcement vehicle to control the position of the boom via the second control part.

17. The communication system of claim 16 wherein the communication apparatus includes both audio and video communication pieces.

18. A method of audio and visual communication between a law enforcement vehicle and a stopped vehicle comprising providing an extendable and retractable boom, controlling the length of extension of the boom from the law enforcement vehicle by providing an end sensor at a distal end of the boom so as to control the position of the boom relative to a driver side view mirror of the stopped vehicle, said end sensor determining a distance between the end of the boom and the driver side view mirror in order to control the extended position of the boom.

19. The method of claim 18 wherein the communication includes providing two-way communication by having a first communication portion adjacent to the stopped vehicle driver side window when the boom is extended and a second communication portion at the law enforcement vehicle.

20. The method of claim 18 wherein the sensing I by means of either a proximity sensing or a touch sensing.
